(19) United States
(12) Patent Application Publication
(10) Pub. No.: US 2011/0315237 A1
(43) Pub. Date: Dec. 29, 2011

(54) DIALYSIS MACHINE AND SYSTEM WITH A DRY EXTERNAL ENVIRONMENT

(76) Inventor: Keith Richard Jenkins, Jefferson, GA (US)

(21) Appl. No.: 13/168,648

(22) Filed: Jun. 24, 2011

Related U.S. Application Data
(60) Provisional application No. 61/358,110, filed on Jun. 24, 2010.

(51) Int. Cl. F16L 55/00

(52) U.S. Cl. 137/312

(57) ABSTRACT

A collection system for collecting leaks from a dialysis machine and either holding the fluid until it can be discharged or letting it drain, the collection system includes a collector for collecting fluid leaking from the pipes, tubes and valves adjacent to the wall or the dialysis machine is located. It also collects fluid leaking from the inside of the dialysis machine for holding or discharging into a sanitary sewer. This bottom collector can have a water alarm to alert an operator that the bottom collector is about to overflow. The dialysis machine can have a built in bottom collector.

This application is a utility application that claims priority to U.S. Provisional Patent Application entitled, “DIALYSIS DRY SYSTEM”, having Ser. No. 61/358,110, filed Jun. 24, 2010 which is entirely incorporated herein by reference.

### FIELD OF THE INVENTION

This invention relates to a system, apparatus and method for collecting any leaks in a dialysis system to prevent the leaks from reaching the floor of the facility.

### BACKGROUND OF THE INVENTION

Dialysis machines and dialysis plumbing have a number of hoses, valves and connections and frequently leak small amounts of fluid onto the floor of the facility which can damage the floor over time and present a health hazard.

### BRIEF DESCRIPTION OF THE DRAWINGS

FIG. 1 is a perspective view of a prior art dialysis machine and environment.

FIG. 2 is a perspective view, similar to FIG. 1 of a dialysis environment retrofitted with the liquid collectors.

FIG. 3 is a perspective view of the bottom collector with a fragmentary portion of the dialysis machine shown exploded away in phantom lines.

FIG. 4 is a cross-sectional view taken generally at inset circle 4 in FIG. 2.

### DETAILED DESCRIPTION OF THE DIALYSIS MACHINE AND SYSTEM WITH A DRY EXTERNAL ENVIRONMENT

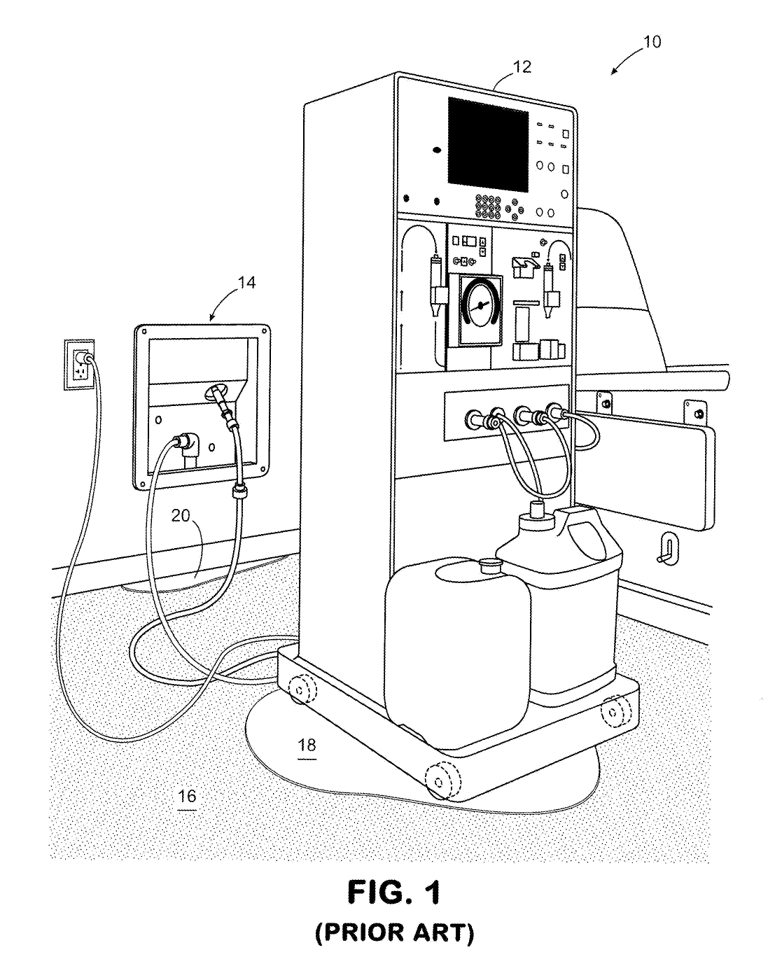

FIG. 1—4 has a following parts list numbers and names:
10—Prior Art Dialysis Machine and Environment;
12—Dialysis Machine;
14—Plumbing Box;
16—Floor;
18—Dialysis Machine Leakage (e.g. water or waste liquid)
20—Plumbing Wall Leakage of Water and Waste Liquid;
100—Dialysis Machine and System with a Dry External Environment;
112—Dialysis Machine;
114—Base Skirt of Dialysis Machine;
116—Wheels of Dialysis of Machine;
118—Water Influent
120—Waste Line (out of machine)
122—Tank for Acid Concentrate;
124—Tank for Bicarbonate Mixture;
126—Patient Chair;
130—Bottom Liquid Collector;
132—Side Walls of Collector;
134—End Wall of Collector;
140—Bottom of Collector;
136A&B—Bottom of Collector Adjacent End Wall;
137—Bottom of Collector Adjacent to Bottom Portions 136A&B;
138—Ramp Section of Bottom;
139—Raised Dam;
142—Drain;
144—Drain Tube;
146—Plug;
150—Moisture Detector and Alarm;
160—Wall Section or Box in Wall;
162—Plumbing Cabinet
164A-B—Valves;
168—Fittings
170—Quick Connect Fittings;
172—Sewer Pipe;
180—Liquid Collector of Leakage from Valves;
182—Drain Pipe
184—Drain;
190—Plumbing Box Collector in Box in Wall or Plumbing Cabinet for Collecting Liquid from the Fittings;
192—Drain Pipe for Collector in Plumbing Box or Cabinet;
194—Drain for Liquid Collector;
196—Plumbing Drain for Collector 190.

### BACKGROUND

FIG. 1 shows prior art dialysis machine 10 dialysis machine and environment. The dialysis machine 12 has liquid lines that extend to connect the two fittings in the plumbing box 14. These fittings may leak water or waste. The direction of the flow of the liquid between the dialysis machine 12 and the plumbing box 14 is indicated by arrows. The leakage from the plumbing wall is indicated by numeral 20. This leakage may be either water or waste.

### BRIEF DESCRIPTION OF THE INVENTION

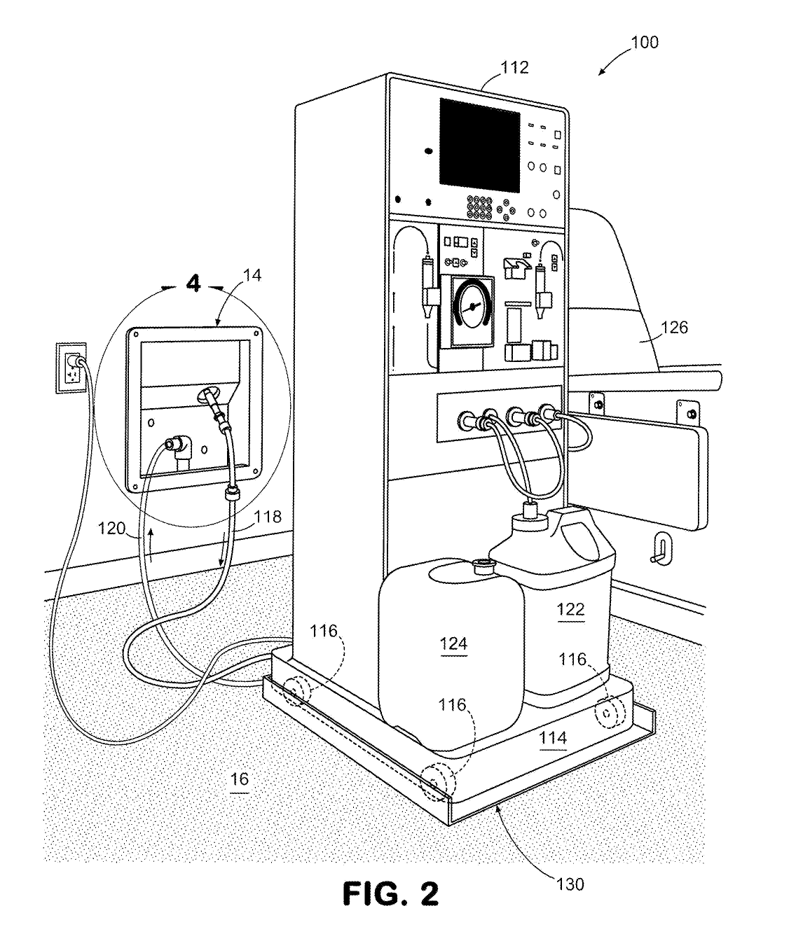

The invention illustrated in FIG. 2 is a view of the dialysis machine 112 and its environment which has been equipped with liquid collectors. The dialysis machine 112 is shown in the environment in which the machine is located. The base skirt 114 of the dialysis machine 112 is supported on wheels 116. A line for carrying water influent 118 to the dialysis machine 112 is shown. A waste line for carrying waste out of the machine 112 to the plumbing box 14 is shown. The direction of flow of liquids in these two lines 118 and 120 is shown by arrows.

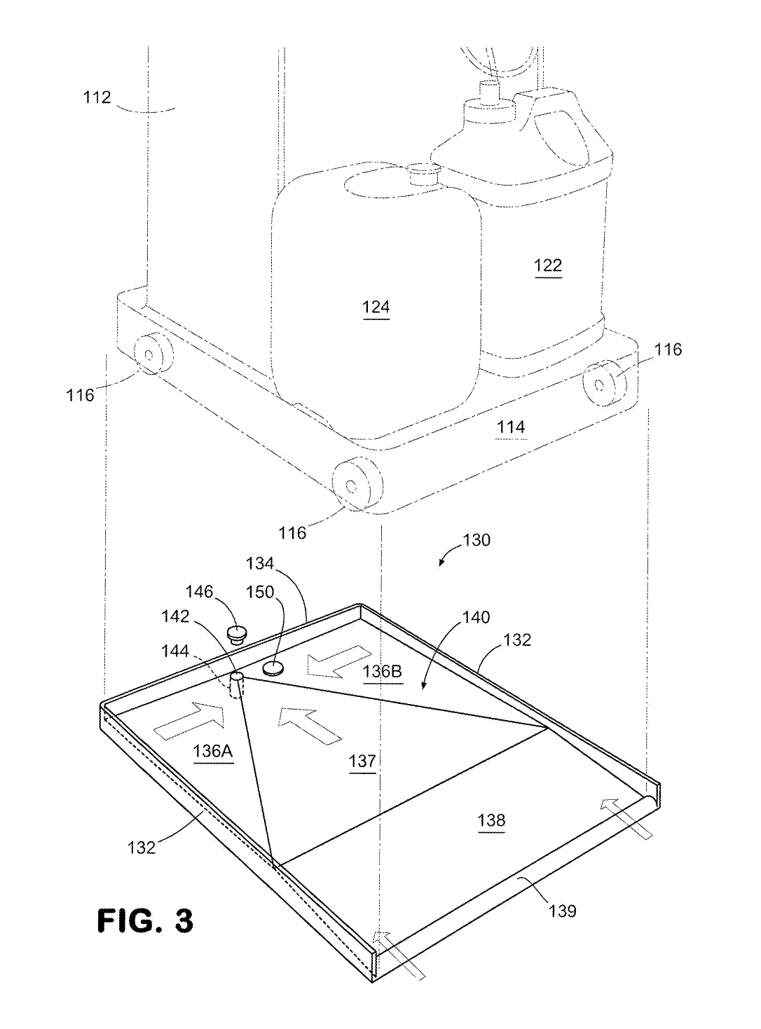

The bottom liquid collector 130 for collecting leakage from the bottom of the dialysis machine 112 is shown in FIGS. 2 and 3. This bottom collector has sidewalls 132 to prevent the liquid from the dialysis machine that drops into the collector from flowing onto the floor 16 where the dialysis machine 112 is located. The end wall 134 serves the same purpose. These side walls 132 and end wall 134 must be of sufficient height to prevent overflowing of the liquid. This bottom collector 130 for leakage from the dialysis machine 112 has a bottom 140. This bottom 140 is preferably divided into three sections. Sections 136A and B of the bottom 140 slope towards each other as indicated by the arrows. The section of the bottom 137 slopes in the direction indicated by the arrow. The slopes of sections 136A and B and 137 allow the liquid waste to flow towards drain 142 which is connected to a sanitary plumbing line or placed over a sanitary drain in the floor (not shown). A drain tube 144 interconnects the drain 142 with a sanitary sewer opening or other pipe (not shown). A plug 146 may be provided for plugging the drain 142 which may be useful in moving the bottom collector 130 when it contains liquid. A moisture detector 150 with an alarm will alert the operator when the liquid in the collector 130 reaches a certain level that may allow it to overflow on the floor 16. Moisture detectors are commercially available and are float activated or with water sensors. This moisture detector 150 could be located as an integral part of plug 146.

The dialysis machine 112 is preferably rolled onto the bottom collector 130 on a ramp section 138 of the bottom 137. This ramp section 138 extends at a slight angle from the floor 16 on which it rests. The dialysis machine is rolled up the ramp 138 in the direction indicated by the arrows on the ramp 138. In order to prevent liquid in the bottom 140 of the collector 140 from flowing down the ramp 138 a raised dam 139 may be provided. This raised dam 139 can be built as an integral part of the collector 130 or it could be a piece that is attached to the collector 130 by screws or other attachment mechanisms. A rubber or plastic strip with an adhesive could form a dam 139 with the adhesive on the bottom of the strip securing the dam 139 to the ramp section 138.

This collector 130 can be molded on a vacuum mold from any suitable plastic such ABS. The collector 130 may be reinforced by strips or ridges (not shown) on the underside of the bottom 140 to strengthen the collector to support a heavy dialysis machine. The collector 130 could be formed of other materials such as steel, or aluminum.

This collector 130 could be formed as an integral part of the dialysis machine 112 when it is manufactured with the wheels 116 placed on the bottom of the collector 130 or outside of the sides 132 of the collector 130. A drain could be placed in the bottom of the collector 130 and it may have a moisture sensor to prevent overflowing.

Tank 122 is designed to hold acid concentrate and tank 124 is designed to hold a bicarbonate mixture for use in the dialysis machine.

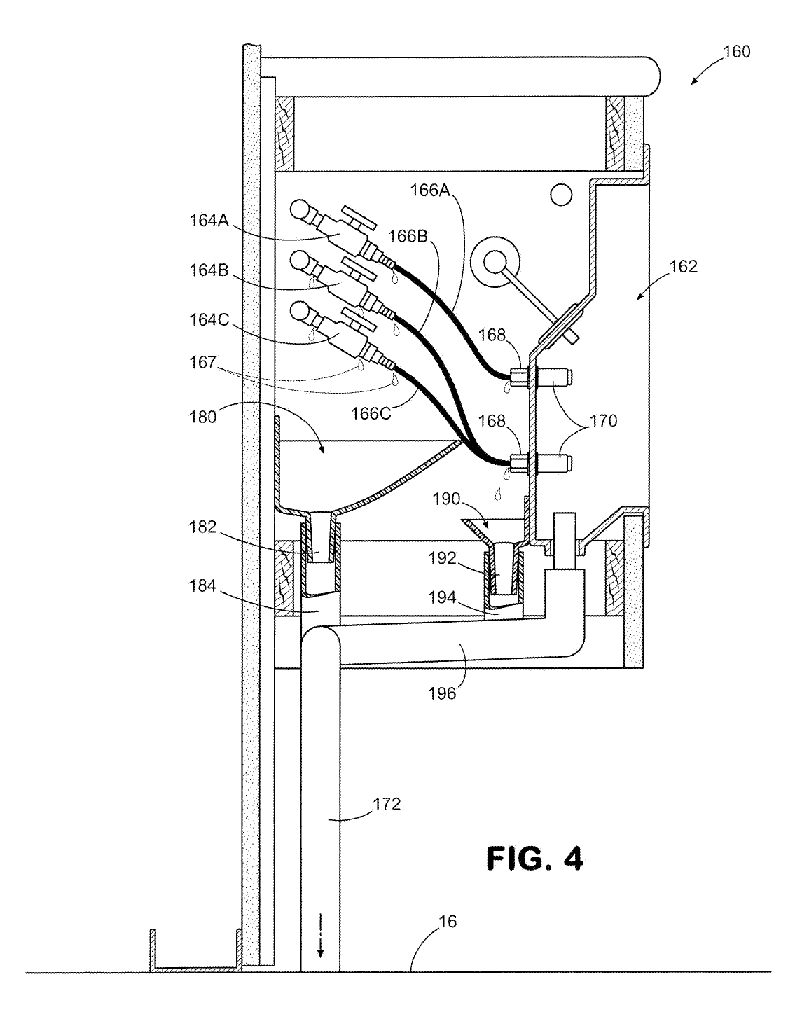

FIG. 4 is a cross sectional view taken generally of the insert circle 4 of FIG. 2. The dialysis machine 112 is connected by one or more liquid lines 166A-C into adjacent wall. A wall section or box in wall 160 is shown in which a plumbing cabinet 162 is located in which the liquid lines 166A-C are connected to a sanitary sewer line (not shown). These lines 166A-C are connected to valves 164 A-C which are connected to the sanitary sewer line in plumbing box 162. As is typical of many attachable connections such as valves 164A-C and liquid lines 166A-C leakage frequently occurs as shown by liquid drops 167 in FIG. 4. If this leakage is not collected, it will form puddles of liquid 20 on the floor as shown in FIG. 1.

The prevention of this leakage onto the floor which results in unsanitary conditions is illustrated in FIG. 4. The leakage from valves 164 A-C and lines 166A-C is collected by liquid collector 180. The liquid drops 167 drop into liquid collector 180 and flows through drain pipe 182 and drain 184 which is connected to drain pipe 172 which allows the liquid to flow into a sanitary drain in the floor 16 or to another pipe to be carried away.

These liquid lines 166A-C are connected to the dialysis machine 112 by fittings 168. Additional fittings 170 for a quick connect may be provided. Leakage from fittings 168 or liquid lines 166 A-C near fitting 168 will drop into plumbing box collector 190 and flow through drain pipe 192 into the plumbing box collector and drain 194 for the box and into drain pipe 196 and sewer pipe 172 and flow to a sanitary sewer opening or further pipe (not shown).

Liquid collectors 180 and plumbing box collector 190 can be constructed with plastic material such as ABS or other suitable plastic and may be formed by a vacuum mold or extruded. It could also be constructed from a similar material such as a metal.

The collection system for collecting leakage from the various fittings and valves of pipes of the dialysis machine is very useful in preventing leaks onto the floor which may damage the floor and also prevent serious health and safety hazard, including mold and damage to walls of the room.

1. A system for the collection of fluid leaks from a dialysis machine or station for accepting fluid from humans and conveying fluid to humans having a bottom base with wheels which comprises:
a. a bottom liquid collector having a bottom, sides for keeping the liquid in the collector and two ends for placing below a dialysis machine which collects fluid leaking into the collector, with a bottom that slopes downward towards one end for keeping the liquid in the collector, with the other end of the bottom being of a sufficient height to keep the liquid in the collector, said other end of the collector having a ramp which slopes from the bottom of the bottom collector to the floor of the room in which the dialysis machine is placed for allowing the dialysis machine to be rolled on its wheels from the floor of the room to the bottom of the bottom liquid collector and back to the floor of the room.

2. A system for the collection of fluid leaks from fluid lines connected to a dialysis machine or station for accepting fluid from humans and conveying fluid to humans, with the machine having a plurality of fluid lines for conveying fluid to and from the machine and a wall section or box in the wall or a room or a plumbing cabinet which is adjacent to a wall which comprises:
a. fluid lines extending into the wall section or box in the wall or plumbing cabinet and connected to plumbing lines that extend into the wall section for supplying liquid to or from the fluid lines, with each fluid line connected to a liquid chamber or line within the dialysis machine, with each fluid line having fittings or valves within the wall section, with the wall section having a liquid collector to collect liquid leaking from the fittings and fluid lines adjacent to the fittings and a liquid collector for collecting liquid leaking from the valves and fluid lines adjacent the valves, with each collector either holding the fluid or connecting a sewer pipe for disposing of the liquid.

3. A system for the collection of fluid leaks from a dialysis machine or station for accepting fluid from humans and conveying fluid to humans having a bottom base with wheels which comprises:
a. a bottom liquid collector having a bottom, sides for keeping the liquid in the collector and two ends for placing below a dialysis machine which collects fluid leaking into the collector, with a bottom that slopes downward towards one end for keeping the liquid in the collector, with the other end of the bottom being of a sufficient height to keep the liquid in the collector, said other end of the collector having a ramp which slopes from the bottom of the bottom collector to the floor of the room in which the dialysis machine is placed for allowing the dialysis machine to be rolled on its wheels from the floor of the room to the bottom of the bottom liquid collector and back to the floor of the room; and
b. with the dialysis machine having a plurality of fluid lines for conveying fluid to and from the machine and a wall section or box in the wall or a room or a plumbing cabinet which are connected to plumbing lines that extend into the wall section for supplying liquid to or from the fluid lines, with each fluid line connected to a liquid chamber or line within the dialysis machine, with each fluid line having fittings or valves within the wall section, with the wall section having a liquid collector to collect liquid leaking from the fittings and fluid lines adjacent to the fittings and a liquid collector for collecting liquid leaking from the valves and fluid lines adjacent the valves, with each collector either holding the fluid or connecting a sewer pipe for disposing of the liquid.

4. A dialysis machine or station for accepting fluid from humans and conveying fluid to humans having a bottom which comprises:
a. a system within the dialysis machine for the collection of fluid leaks within the dialysis machine or station which has a bottom liquid collector having a bottom and two sides and two ends having sufficient height for keeping the liquid in the collector which collects fluid leaking into the collector, with the dialysis machine having wheels placed on the bottom of the machine for allowing the dialysis machine to be rolled on its wheels along the floor of the room, with the dialysis machine having means for removing the fluid from the bottom collector.

5. The dialysis machine of claim 4 in which the means for removing fluid from the bottom collector is a drain in which the bottom slopes towards the drain and a moisture detector which senses the level of fluid in the collector and has an alarm to alert the operator of the level of the fluid in the collector.

6. The dialysis machine of claim 5 which also has a plurality of fluid lines for conveying fluid to and from the machine and a wall section or box in the wall or a room or a plumbing cabinet which are connected to plumbing lines that extend into the wall section for supplying liquid to or from the fluid lines, with each fluid line connected to a liquid chamber or line within the dialysis machine, with each fluid line having fittings or valves within the wall section, with the wall section having a liquid collector to collect liquid leaking from the fittings and fluid lines adjacent to the fittings and a liquid collector for collecting liquid leaking from the valves and fluid lines adjacent the valves, with each collector either holding the fluid or connecting a sewer pipe for disposing of the liquid.

7. The system of claim 3 which also has a moisture detector in the bottom liquid collector (a) which senses the level of fluid in the collector and an alarm to alert the operator of the level of the fluid in the collector.

8. The system of claim 3 in which the bottom of the bottom liquid collector(a) has drain for draining fluid and the bottom is designed to slope towards the drain.

9. The system of claim 8 which also has a moisture detector in the bottom liquid collector (a) which senses the level of fluid in the collector and an alarm to alert the operator of the level of the fluid in the collector.

10. The system of claim 1 which also has a moisture detector which senses the level of fluid in the collector and an alarm to alert the operator of the level of the fluid in the collector.

11. The system of claim 1 which has a dam, similar to a speed bump, for preventing fluid from flowing from the bottom collector down the ramp, but permitting the dialysis machine to be rolled into and out of the bottom collector.

12. The system of claim 3 which has a dam, similar to a speed bump, for preventing fluid from flowing from the bottom collector(a) down the ramp, but permitting the dialysis machine to be rolled into and out of the bottom collector of claim 1 which has a water alarm to prevent the floor catch basin from overflowing.
